(19) United States
(12) Patent Application Publication
(10) Pub. No.: US 2009/0263655 A1
(43) Pub. Date: Oct. 22, 2009

(54) DYE MIXTURES

(75) Inventors: Bruce Owen Griffin, Kernersville, NC (US); Jack Thurman Larkins, JR., Kernersville, NC (US); Margo Roome Atkins, High Point, NC (US)

Correspondence Address: Patent Counsel;Huntsman International LLC, Legal Dept., 10003 Woodloch Forest Drive, The Woodlands, TX, 77380, US

(73) Assignee: Huntsman International LLC, The Woodlands, TX (US)

(21) Appl. No.: 12/490,754

(22) Filed: Jun. 24, 2009

Related U.S. Application Data
(63) Continuation of application No. 10/762,023, filed on Jan. 21, 2004, now abandoned.

(51) Int. Cl. C09B 67/22; B32B 3/00

(52) U.S. Cl. 428/375; 8/639; 8/643; 8/638

(57) ABSTRACT

The present invention discloses mixtures of dyes, dye compositions comprising them and the use of said mixtures and compositions, optionally in combination with UV absorbers, to dye or print textile materials, particularly hydrophobic textile materials such as polyester, that must meet stringent lightfastness requirements. Fibers dyed with the inventive dye mixtures exhibit exceptional high temperature light fastness and good all-round fastness properties.

The present invention is directed to mixtures of dyes, to dye compositions comprising them and to the use of said mixtures and compositions, optionally in combination with UV absorbers, to dye or print textile materials, particularly hydrophobic textile materials that must meet stringent lightfastness requirements.

Over the last five to ten years the automotive fabrics industry has undergone significant changes in its testing requirements, particularly lightfastness testing requirements. Prior to 2002, Chrysler, Ford, and GM accepted the SAE J1885 lightfastness test method. This test method exhibits a light spectrum that degrades the blue chromophore more than the yellow chromophore. Therefore, fabrics intended for the automotive industry were almost universally dyed with mixtures comprising dyes and benzotriazole UV absorbers for lightfastness since benzotriazole UV absorbers more strongly protected the blue chromophores.

General Motors (GM) and Ford have implemented several new test methods in the last few years. Also the Japanese auto industry has built fabric dyehouses in the US recently and implemented test methods not used in the US before. Examples of recently implemented test methods include the GM requirements for lightfastness as specified in GM2751M for upholstery, GM2746M for headliner, GM9538P outdoor weathering test method and GMW3414 accelerated test method as well as other hot lightfastness test methods such as Toyota's TSL2606G and Honda's JASO M346/93.

Most of the changes in the test methods increase the severity of the testing in terms of the temperature of exposure, length of exposure, and they reduce the filtering of the light source, which is typically radiation from a xenon bulb of some type. The light spectrum employed in these tests is also more detrimental toward the yellow chromophores. All of these factors have dramatically increased the failure rate of the traditional dyeing chemistries used to color textile fabrics such as automotive fabrics.

Also the fabric constructions are trending to lower fiber cross-sections, for example from a high cross-section of 4.0 denier per filament to a low of 0.19 denier per filament. For these low denier fabrics the ratio of surface area exposed to fiber mass increases exponentially. This results in fabrics that exhibit color fade and strength loss that proves very difficult to overcome.

The fabrics of interest consist predominately of polyester fibers, nylon fibers and mixtures thereof, particularly those that are to be used in fabrics such as seat upholstery, headliners, carpeting and door panels of automotive vehicles as well as those that are to be used in outdoor applications such as patio and poolside furniture.

These fabrics are usually dyed in an aqueous medium by the exhaust method, pad steam method, pad bake and/or thermosol method.

It has now surprisingly been found that fibers dyed with certain dye mixtures exhibit exceptional high temperature light fastness and that exhibit good all-round fastness properties relative to fibers dyed with the constituent dyes, and that fibers dyed with dye compositions comprising these mixtures and selected UV absorbers can be used to produce dyed fabrics which can meet the most stringent lightfastness requirements, both now and for the seeable future.

Thus, one aspect of the present invention is dye mixtures comprising:

(A) a yellow-dyeing mixture of the dye of the formula I

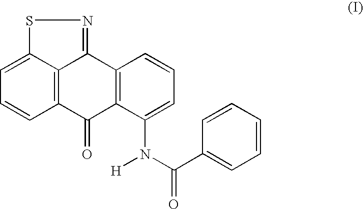

together with the dye of the formula II

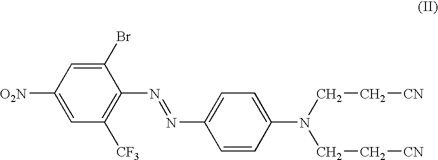

or the dye of the formula III

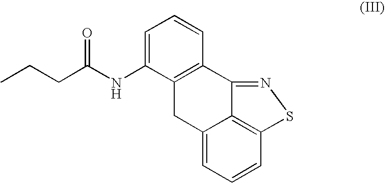

or the dye of the formula IV

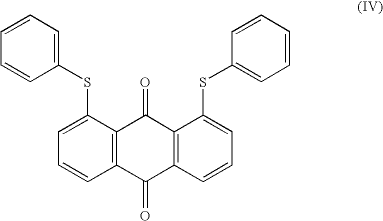

or the dye of the formula V

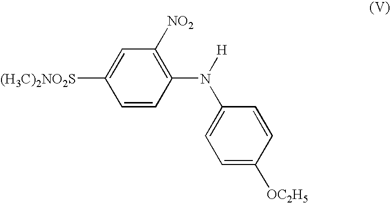

or the dye of the formula VI

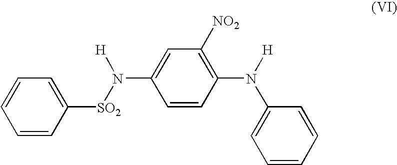

or with a mixture of two or more dyes of the formulae (II)-(VI);
or the dye of the formula IV

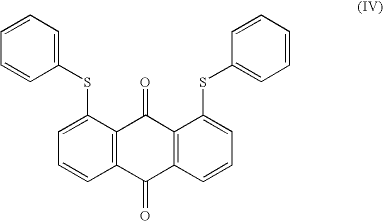

together with the dye of the formula II

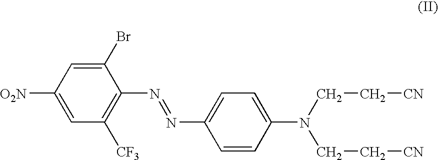

and/or the dye of the formula III

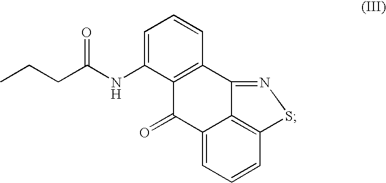

or
(B) a red-dyeing mixture comprising a mixture of dyes of the formulae VIIa-VIIf

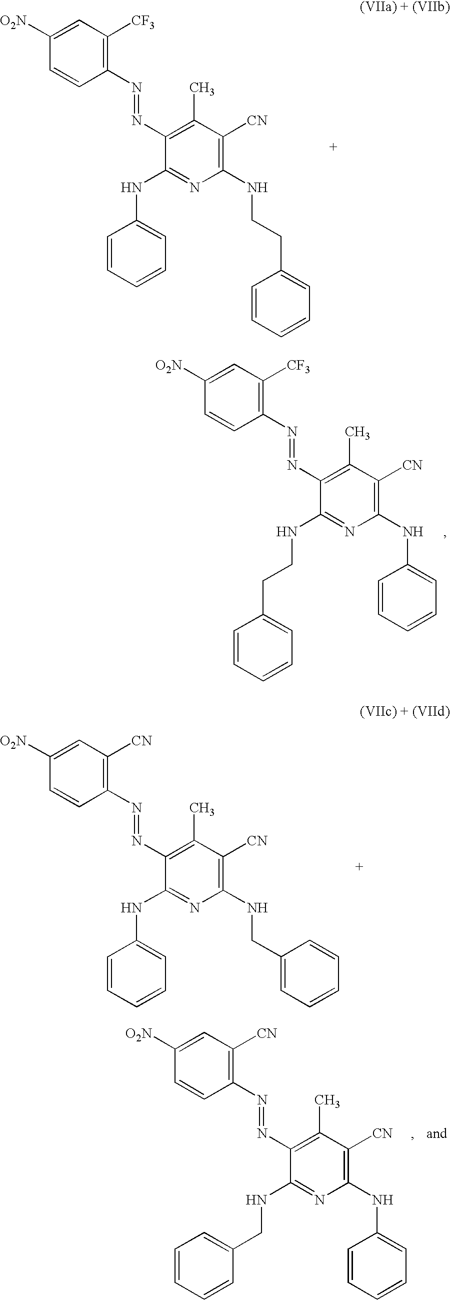

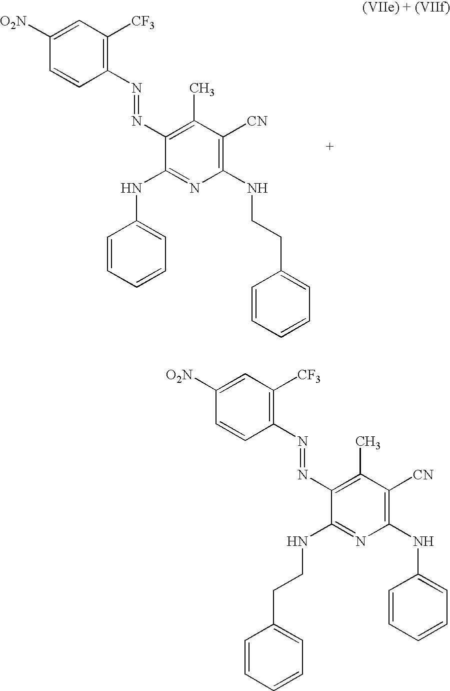

together with a mixture of the dyes formula VIII

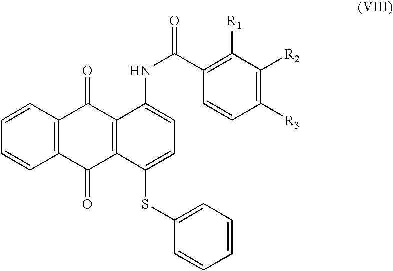

where one of R₁, R₂ and R₃ is Cl and, in each case, the other two substituents are both H;
or
   (C) a blue-dyeing mixture comprising the dye of the formula IX

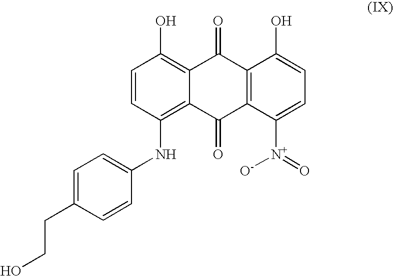

together with a mixture of dyes of the formulae Xa and Xb

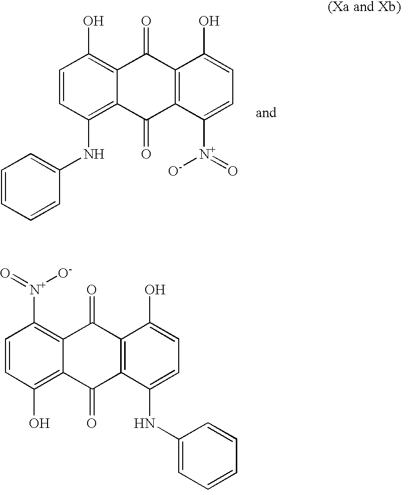

and, optionally, also the dye of the formula XI

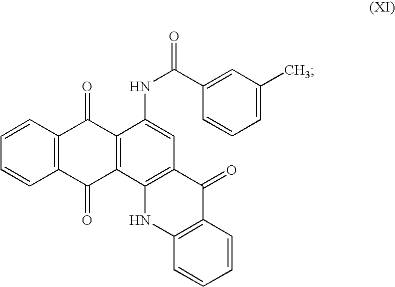

or a blue-dyeing mixture comprising the dye of the formula IX

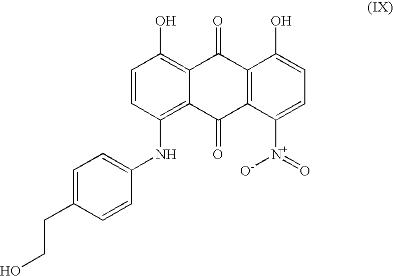

together with a mixture of dyes of the formulae XIII plus Xa

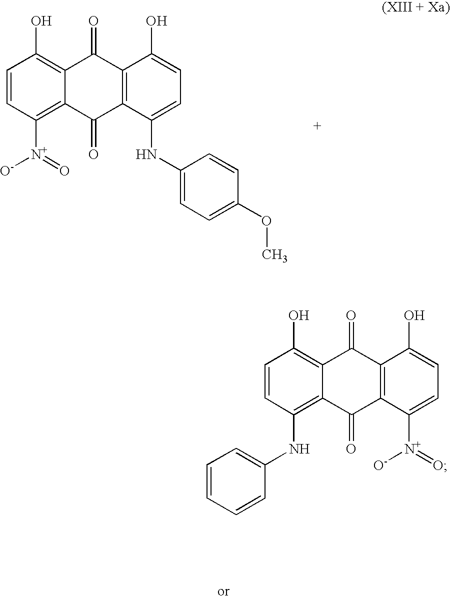

(D) a black-dyeing mixture comprising the dye of the formula I

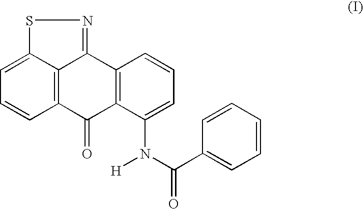

and the dye of the formula IV

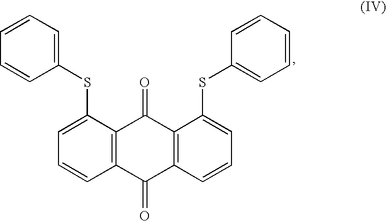

or a mixture comprising the dye of the formula I and/or the dye of the formula II together with the dye of the formula II

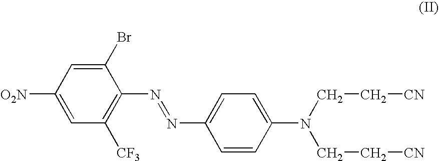

together with a mixture of dyes of the formulae VIIa-VIIf

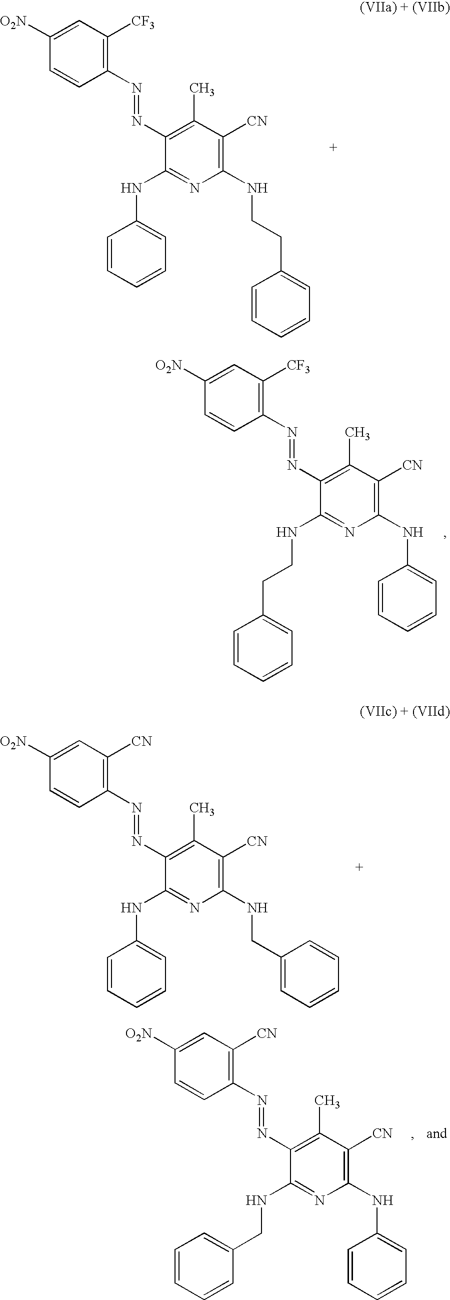

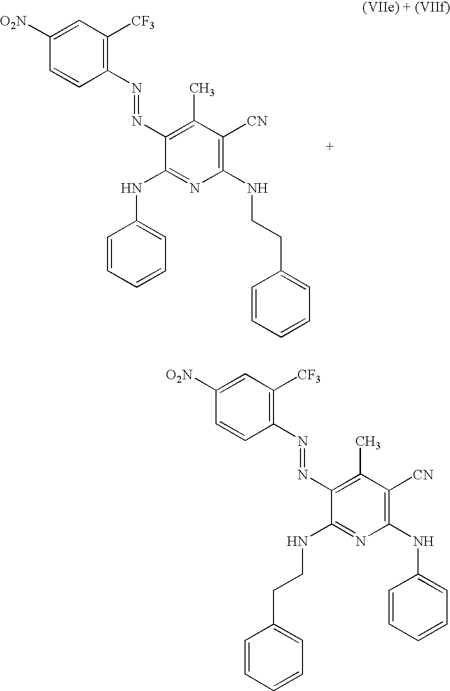

together with a mixture of dyes of the formula Xa and Xb

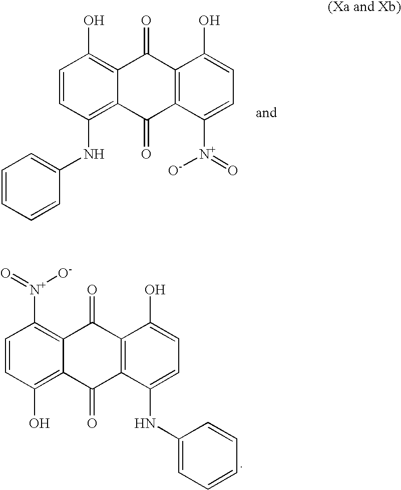

Preferred are dye mixtures comprising:

(A) a yellow-dyeing mixture of the dye of the formula I

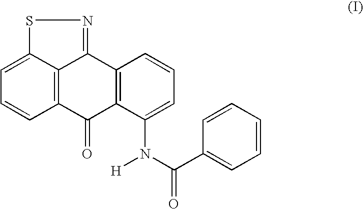

together with the dye of the formula II

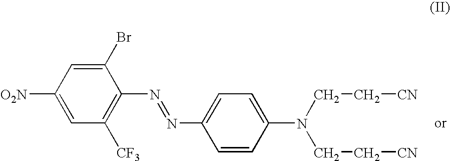

(B) a red-dyeing mixture comprising a mixture of dyes of the formulae VIIa-VIIf

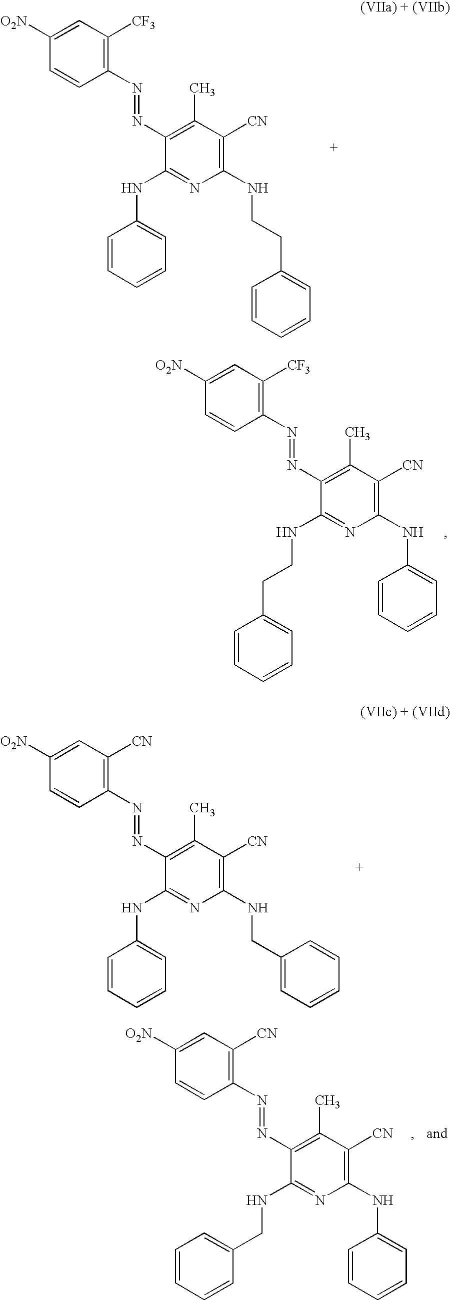

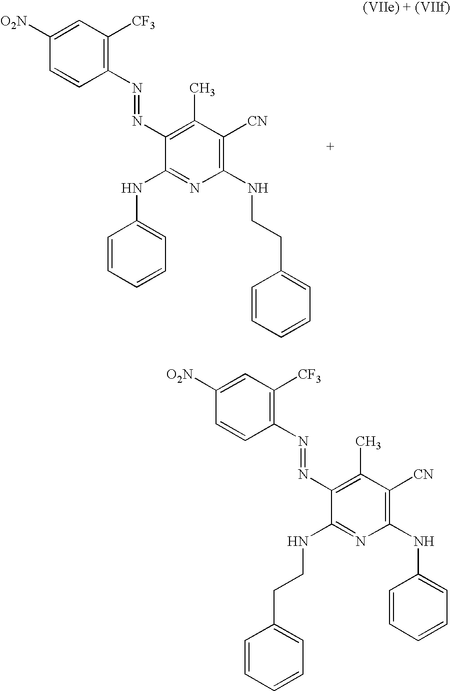

together with at least one dye of the formula VIII

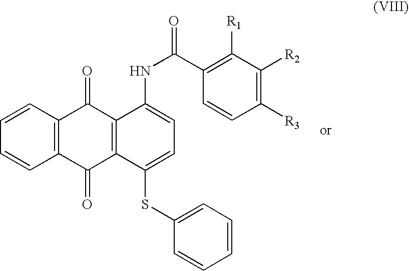

(C) a blue-dyeing mixture comprising the dye of the formula IX

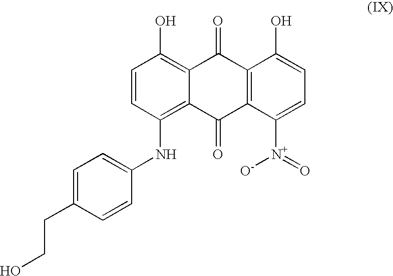

together with a mixture of dyes of the formulae Xa and Xb

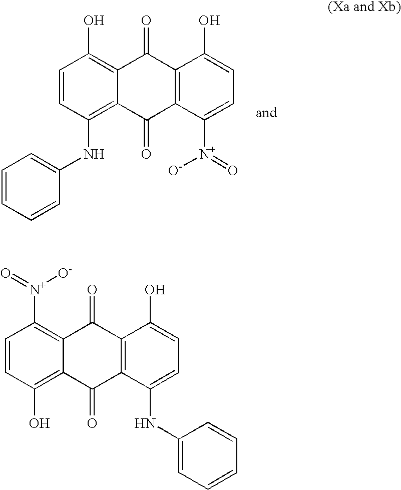

and/or the dye of the formula XI

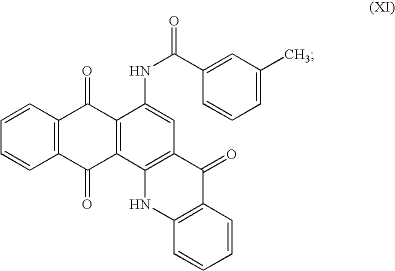

or
   (D) a black-dyeing mixture comprising the dye of the formula I

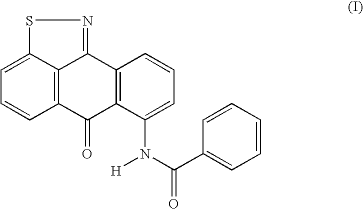

together with the dye of the formula II

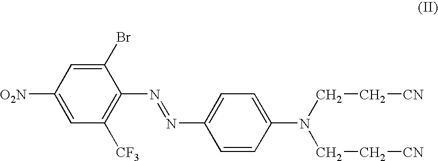

together with a mixture of dyes of the formulae VIIa-VIIf

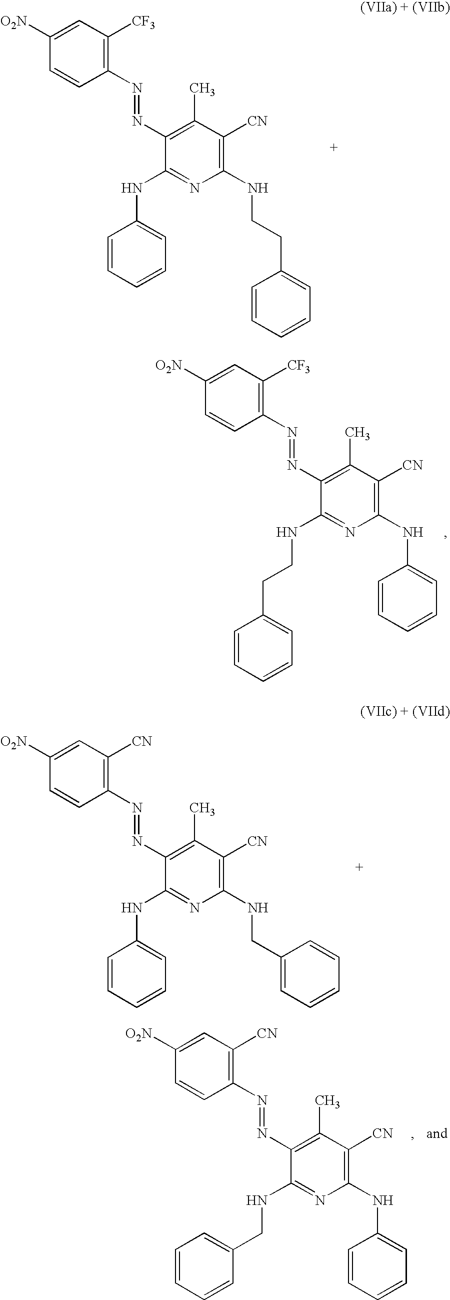

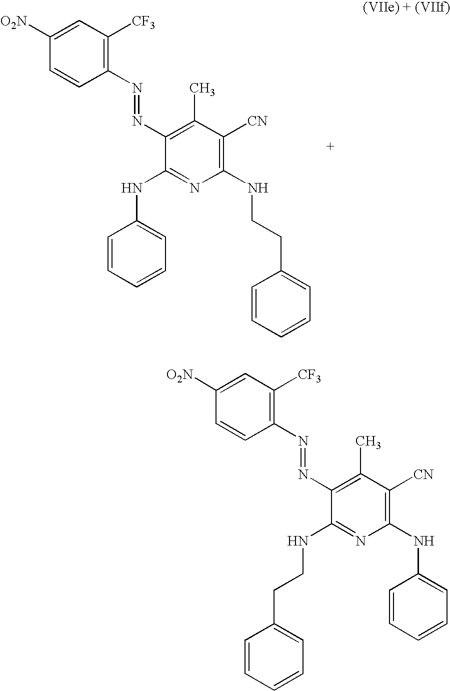

together with a mixture of dyes of the formula Xa and Xb

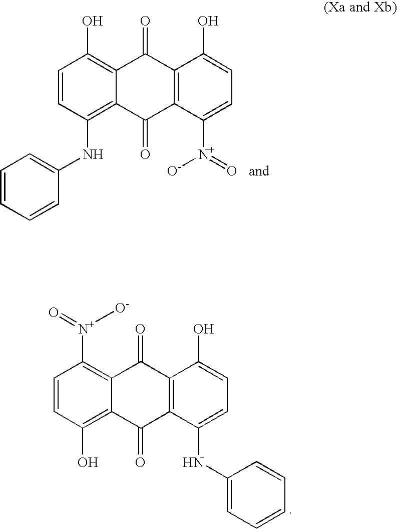

While the dye mixtures can be used alone, normally they will be used in dichromatic or trichromatic combinations comprising two, three or all four of the mixtures (A), (B), (C) and (D).

Additionally, any of the dye mixtures (A), (B), (C) or (D), or any combination thereof, can be used not only with each other but also with further dyes.

One embodiment of this comprises a mixture of dyes of the formula XIV

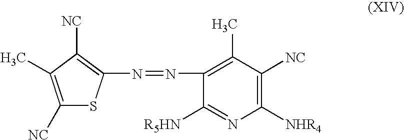

where one of R₄ and R₅ is H and the other is (CH₂)₂O(CH₂)₂OCOCH₃ or (CH₂)₂O(CH₂)₂OH or the dye of the formula XV

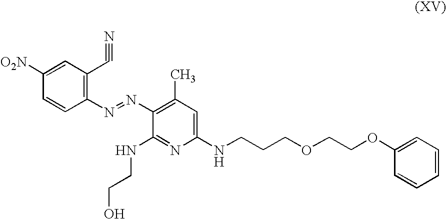

or the dye of the formula XVI

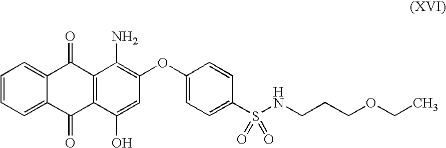

or the dye of the formula XVII

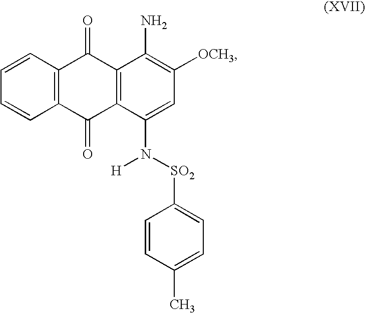

or a mixture of dyes of the formulae XVIIIa and XVIIIb

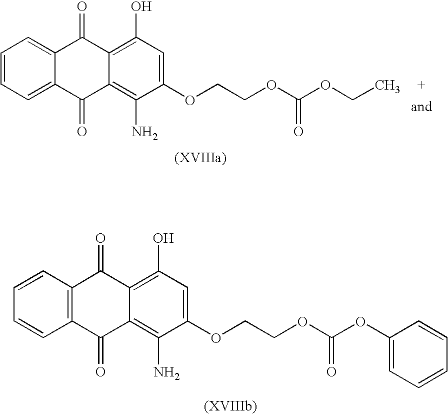

or a dye of the formula XIX

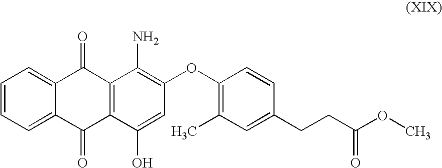

or a mixture of dyes of the formulae XXa and XXb

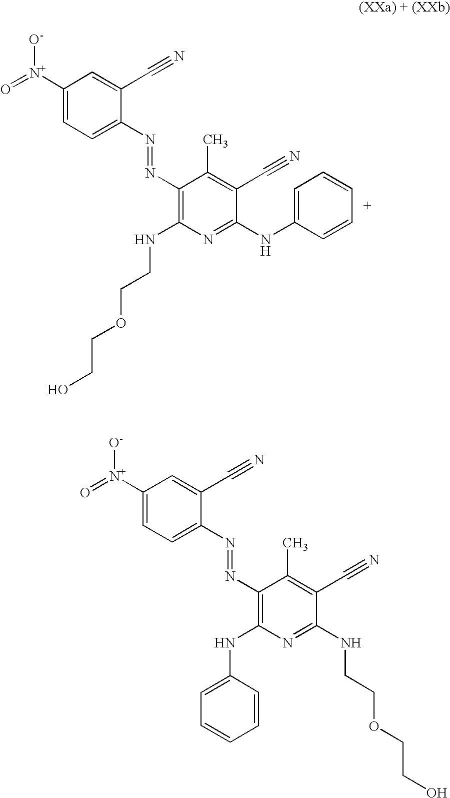

or any combination thereof in combination with any of the dye mixtures (A), (B), (C) or (D) or any combination thereof. In a preferred embodiment at least one of the above dyes is used in addition to the red-dying mixture (B) or as a replacement for it.

Another embodiment of this comprises the dye of the formula XXI

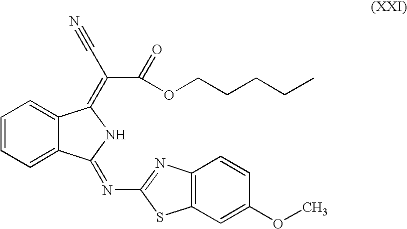

and/or the dye of the formula XXII

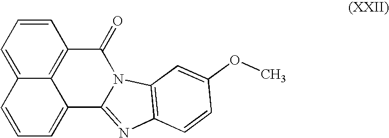

in combination with any of the dye mixtures (A), (B), (C) or (D) or any combination thereof. In a preferred embodiment at least one of the above dyes is used in addition to the yellow-dying mixture (A) or as a replacement for it.

Another embodiment of this comprises the dye of the formula IX

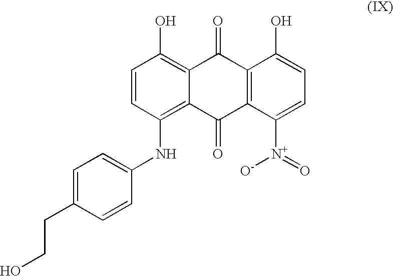

together with the dye of the formula Xa

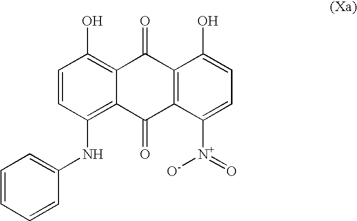

alone, or together with a mixture of dyes of the formulae

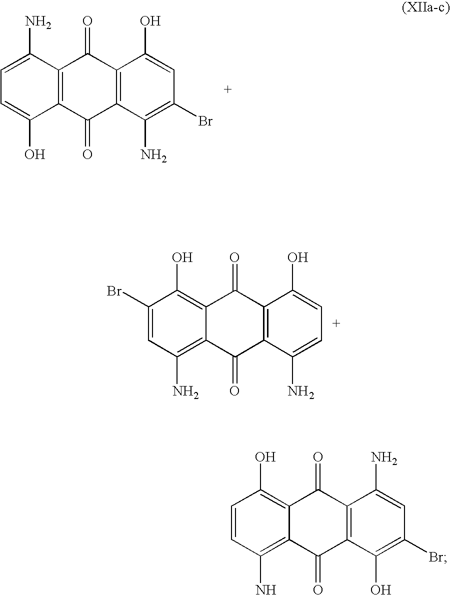

in combination with any of the dye mixtures (A), (B), (C) or (D) or any combination thereof. In a preferred embodiment at least one of the above dyes is used in addition to the blue-dying mixture (C) or as a replacement for it.

The amount of the individual dyes to use in the dye mixtures (A), (B), (C) and (D) can vary considerably depending on the exact hue and other effects desired.

Dye mixture (A) generally comprises from 5 to 90 weight %, preferably from 10 to 60 weight % of the dye of the formula I in combination with from 10 to 95 weight %, preferably from 40 to 90 weight % of at least one dye of the formula II-VI. Preferred is a mixture comprising from 10 to 40 weight %, of the dye of the formula I in combination with from 60 to 90 weight % of the dye of the formula II.

Dye mixture (B) generally comprises from 1 to 99 weight %, preferably from 40 to 95 weight % of the dye mixture of the formulae VIIa-VIIf in combination with from 1 to 99 weight %, preferably from 5 to 60 weight % of the dye mixture of the formulae VIII.

Dye mixture (C) generally comprises from 1 to 99 weight %, preferably from 15 to 80 weight % of the dye of the formula IX in combination with from 1 to 99 weight %, preferably from 20 to 85 weight % of the dye mixture of the formula Xa+Xb and, optionally, from 0 to 60 weight % of the dye of the formula XI; or from 1 to 99 weight %, preferably from 15 to 80 weight % of the dye of the formula IX in combination with from 1 to 99 weight %, preferably from 20 to 80 weight % of a dye of the formula Xa in combination with a dye mixture of the formula XIIa-c or a mixture of dyes the formulae XIII plus Xa. Preferred is a mixture comprising from 20 to 65 weight % of the dye of the formula IX in combination with from 20 to 70 weight % of the dye mixture of the formula Xa+Xb plus from 5 to 40 weight % of the dye of the formula XI, with the proviso that the sum of the dyes of the formulae IX, Xa+Xb and XI is 100 weight %.

Dye mixture (D) generally comprises from 1 to 40 weight %, preferably from 3 to 20 weight % of the dye of the formula I and/or the dye of the formula IV in combination with from 0 to 60 weight %, preferably from 15 to 45 weight % of the dye of the formula II plus from 2 to 25 weight %, preferably from 5 to 14 weight % of the dye of the formula VIIa-VIIf, VII, XIV, XV, XVI, XVII, XVIIIa+XVIIIb, XIX or XXa+XXb and from 15 to 80 weight %, preferably from 25 to 65 weight % of the dye mixture of the formulae Xa+Xb.

The individual dyes of the formulae above as well as the dye mixtures of the formulae VIIa-VIIf, VIII, Xa+Xb, XIV, XVIIIa+XVIIIb and XXa+XXb are all known per se and are commercially available, in most cases from Ciba Specialty Chemicals Corporation, in the form of dye preparations.

Dye mixtures according to the invention may be prepared by a variety of methods known in the art, for example by simply mixing 2 or more of the individual dry dyes on a roller-milling machine until homogeneous.

Alternatively mixtures of the individual crude dyes or presscakes can be ground in water in the presence of a dispersant, then mixed and optionally dried to obtain dye preparations comprising the dye mixtures and the dispersant.

It is advantageous to convert the dye mixtures according to the invention into dye preparations prior to use. In one embodiment, the mixtures of dyes are ground. This grinding preferably takes place in mills, for example ball, vibratory, bead or sand mills, or in kneaders. After grinding, the dye particle size is preferably about 0.1 to 10 microns, especially about 1 micron.

The grinding preferably takes place in the presence of dispersants, which can be nonionic or anionic. Nonionic dispersants are for example reaction products of alkylene oxides, for example ethylene oxide or propylene oxide, with alkylatable compounds, for example fatty alcohols, fatty amines, fatty acids, phenols, alkylphenols and carboxamides. Anionic dispersants are for example ligninsulfonates and salts thereof, alkyl- or alkylaryl-sulfonates, alkylaryl polyglycol ether sulfates, alkali metal salts of the condensation products of naphthalenesulfonic acids and formaldehyde, polyvinyl sulfonates and ethoxylated novolaks.

Thus, the mixture of dried dyes is ground with a dispersant or is kneaded in paste form with a dispersant and then dried in vacuo or by atomization. The preparations so obtained can be used, after the addition of water, to prepare printing pastes and dyebaths.

Where the individual dyes are already in the form of dye preparations, mixtures of 2 or more of the individual dry dye preparations can simply be mixed on a roller-milling machine until homogeneous.

The invention therefore also provides dye preparations comprising 10 to 60% by weight of at least one dye mixture according to the invention, and 40 to 90% by weight of dispersant, based on the total weight of the dye mixture and dispersant.

The dye preparations can be present in liquid or solid form, in which case the liquid preparations are preferably aqueous dye dispersions and the solid preparations are present as powders or granules.

Preferred aqueous dye preparations comprise 5 to 50% by weight of at least one dye mixture according to the invention, 10 to 25% by weight of dispersant, the balance being water and further auxiliaries in conventional amounts, each based on the dye preparation.

Preferred dispersants are the abovementioned nonionic and anionic dispersants.

The further auxiliaries in the dye preparations according to the invention may comprise, for example auxiliaries which act as oxidizing agents, e.g. sodium m-nitrobenzenesulfonate, or fungicidal agents, e.g. sodium o-phenylphenoxide and sodium pentachlorophenoxide. It is also possible for wetting agents, antifreeze agents, dustproofing agents or hydrophilicizing agents to be included.

For certain applications, solid preparations such as powdered or granular preparations are preferred. Preferred solid dye preparations comprise 30 to 50% by weight of at least one dye mixture according to the invention, and 70 to 50% by weight of a dispersant.

They may optionally further comprise auxiliaries, for example wetting, oxidizing, preserving and dustproofing agents.

A preferred process for producing the solid preparations consists in removal of the liquid from the above-described liquid dye preparations, for example by vacuum drying, freeze drying, by drying on drum dryers, or, preferably, by spray drying.

To produce dyeing liquors, the requisite amounts of the dye preparations produced as described above are diluted with the dyeing medium, preferably water, to such an extent that a suitable liquor ratio is obtained for the dyeing. In addition, the liquors generally have added to them further dyeing auxiliaries, such as carriers, dispersants and wetting agents.

Another aspect of the present invention is a dye liquor which comprises at least one of the dye mixtures (A), (B), (C) or (D), alone or in combination with other dyes, and, optionally, at least one UV absorber. Preferably the dye liquor comprises at least one UV absorber.

In one embodiment the UV absorber is an s-triazine UV absorber, a benzotriazole UV absorber, a benzophenone UV absorber, or a mixture thereof.

Preferred s-triazine UV absorbers include those known from U.S. Pat. Nos. 4,831,068, 5,182,389, 5,575,958, 5,649,980, 5,871,669 and 5,997,769, the disclosures of which are incorporated by reference in their entirety.

In one embodiment the s-triazine UV absorber is of the formula 1 or 2 or is a mixture of the formulae 2+3

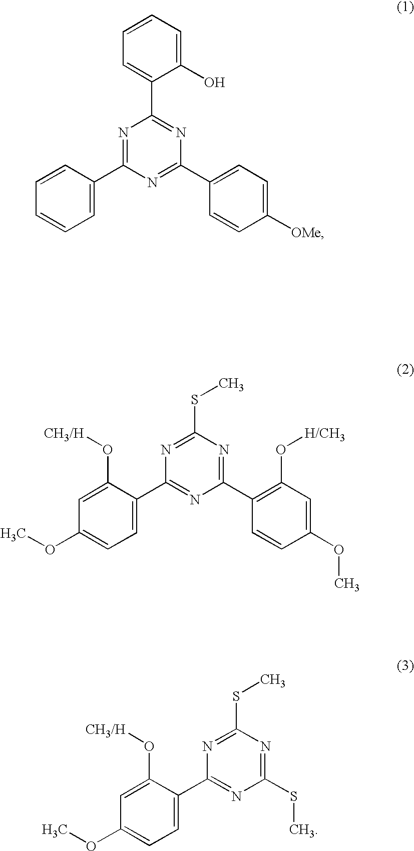

Preferably the s-triazine UV absorber is of the formula 1 or is the mixture of the formulae 2+3.

In another embodiment the UV absorber is benzotriazole UV absorber. Preferred benzotriazole UV absorbers include compounds of the formula 4

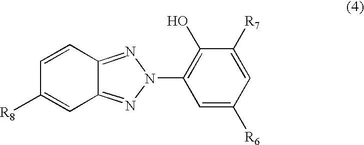

wherein R₆ is halogen, C₁-C₁₂alkyl or C₁-C₁₂alkoxy and R₇ and R₈ are each independently of the other hydrogen, halogen, CF₃, C₁-C₁₂alkyl or C₁-C₁₂alkoxy. The preferred halogen is chlorine.

Said compounds and aqueous dispersions comprising them are known from U.S. Pat. No. 5,009,669, the disclosure of which is incorporated by reference in its entirety.

The benzotriazole UV absorber compound of the formula 4a

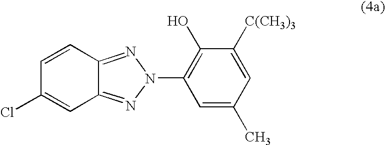

is especially preferred.

Compounds of the above formulae 1, 2, 3 and 4a are known per se and are commercially available from Ciba Specialty Chemicals Corporation in the form of aqueous dispersions. Compounds of the general formula 4 are either known per se and are commercially available, in most cases from Ciba Specialty Chemicals Corporation, or they can be prepared by known methods.

In one embodiment a mixture of the s-triazine UV absorber of the formula 1 or the mixture 2+3 is employed in combination with a benzotriazole UV absorber of the formula 4a.

When the mixture of the s-triazine UV absorber of the formula 1 or the mixture of the formula 2+3 is employed in combination with a benzotriazole UV absorber of the formula 4a or a benzophenone UV absorber, the mixture generally comprises from 5 to 85 weight %, preferably from 15 to 55 weight % of the s-triazine UV absorber and from 15 to 95 weight %, preferably from 45 to 85 weight % of the benzotriazole or benzophenone UV absorber.

The amount of the UV absorber can vary from about 0.02% to 3% by weight, preferably from about 0.05% to 1.5% by weight, especially 0.06% to 1% by weight, based on the total weight of the fabric. While use of a benzotriazole UV absorber alone often suffices to meet current standards, it has been found that a mixture comprising one or more s-triazine UV absorbers plus a benzotriazole UV absorber provides best coverage of the light spectrum to protect the dyed textiles from heat and light degradation. This combination of UV absorbers enables dyeings with the inventive dye mixtures to surpass the most stringent lightfastness test standards.

Synthetic hydrophobic textile materials consist especially of linear, aromatic polyesters, for example those of terephthalic acid and glycols, especially ethylene glycol, or condensation products of terephthalic acid and 1,4-bis(hydroxymethyl)cyclohexane; of polycarbonates, e.g. those of α,α-dimethyl-4,4-dihydroxy-diphenylmethane and phosgene.

The application of the dye compositions according to the invention to the textile materials is effected in accordance with known dyeing procedures. For example, polyester fiber materials are dyed in the exhaust process from an aqueous dispersion in the presence of dyeing assistants such as customary anionic or non-ionic dispersants and optionally customary swelling agents (carriers) at temperatures of from 70 to 145° C. It is preferably within the range of 80 to 135° C.

The dye mixtures and dye preparations according to the invention are suitable for dyeing in accordance with the pad bake and/or thermosol process, in the exhaust process and in a continuous process and for various printing processes. The exhaust process is preferred. The liquor ratio is dependent upon the nature of the apparatus, the substrate and the form of make-up. It may, however, be selected within a wide range, e.g. from 1:4 to 1:100, but is preferably from 1:6 to 1:25.

Preferably, the bath which contains the dye, the dye assistant mixture, UV absorber and any further additives and which has been adjusted to pH 4.5-5.5 is circulated at 60-80° C. through the fiber material for 5 minutes; the temperature is then raised to 110-135° C. in the course of 15 to 35 minutes and the dyeing liquor is left at that temperature for 15 to 90 minutes. Alternatively, the bath which contains the dye, the dye assistant mixture, UV absorber and any further additives can be adjusted to an alkaline pH of 8.5-11 and then conducting dyeing as above in the presence of a pH buffer.

The dyeings are finished by cooling the dyeing liquor down to 60-80° C., rinsing the dyeing with water and, if necessary, reduction fixing it in a conventional manner in an alkaline medium. The dyeing is then rinsed again and dried. This produces on synthetic fiber material, in particular on linear polyester fibers, deep and level dyeings, which, furthermore, are notable for good light fastness and rub fastness.

The textile material employed can be in a variety of processing forms, e.g. in the form of fibers, yarns or non-wovens as well as in the form of woven fabrics or knitted fabrics.

In one embodiment an aqueous dispersion of the dye mixture is prepared by pasting up the dyes, the dispersing mixture and water in a mixer and, following any addition of the desired additional constituents such as sequestering agents, antifreezes, antifoams, preservatives and bactericides, dispersing for 1 to 30, preferably 1 to 10 hours. The dispersing is advantageously effected through the action of high shear forces, for example by grinding in a ball, sand or bead mill. Following grinding, an aqueous solution of a stabilizing or thickening agent and if desired further water can be added and stirred in until uniformly dispersed.

The resulting preparation according to the invention is used in the dyeing of textile material containing synthetic fibers, in particular polyester fibers. The dyeing method is carried out in a conventional manner, i.e. the solid or liquid preparation according to the invention is slowly added with stirring to an aqueous bath and the resulting dye liquor is ready for dyeing.

The printing of the hydrophobic materials mentioned can be carried out in a conventional manner by incorporating the dye mixtures of the invention into a print paste, printing the fabric therewith and treating the fabric printed therewith at temperatures between 140 to 230° C. with superheated steam or dry heat to fix the dyes, optionally in the presence of a carrier.

Customary printing thickeners will be used for the print paste, e.g. modified or unmodified natural products, for example alginates, British gum, gum arabic, crystal gum, locust bean flour, tragacanth, carboxymethylcellulose, hydroxyethylcellulose, starch or synthetic products, for example polyacrylamides, polyacrylic acid or copolymers thereof, or polyvinyl alcohols.

The dye liquors according to the invention comprising at least one dye mixture described above in combination with at least one UV absorber impart to the above-mentioned materials, especially to polyester material, level color shades having very good in-use fastness properties, such as, especially, good fastness to light, more especially very good high temperature light fastness, fastness to thermofixing, to pleating, to chlorine and to wetting, such as fastness to water, perspiration and washing; the finished dyeings are also distinguished by good fastness to rubbing. It has surprisingly been found that fibers dyed with at least one dye mixture described above in combination with at least one UV absorber exhibit exceptional heat and light stability relative to fibers dyed with the constituent dyes, and that the fibers so dyed can be used to produce dyed fabrics which can meet the most stringent high temperature lightfastness requirements, both now and for the foreseeable future.

The dye mixtures according to the invention can also be used satisfactorily in the preparation of mixed shades together with other dyes. In this regard the dye mixtures according to the invention can be used especially as suitable components in a trichromatic dyeing or printing technique.

The dye compositions according to the invention are also very suitable for dyeing hydrophobic textile material from supercritical CO₂.

The dye mixtures according to the invention are used in the dyeing or printing of synthetic hydrophobic fiber materials, more especially hydrophobic textile materials. Thus, another aspect of the present invention is a method of dyeing or printing synthetic hydrophobic fiber materials, which comprises dyeing said materials with at least one of the dye mixtures (A), (B), (C) or (D), alone or in combination with other dyes, optionally in the presence of at least one UV absorber. Preferably at least one UV absorber is employed. The preferences with regard to the dye mixtures and UV absorbers are as described above. The hydrophobic fiber material is preferably polyester textile material.

The present invention relates also to hydrophobic fibre material, especially polyester textile material, which has been dyed or printed by the process according to the invention.

The following examples describe certain embodiments of this invention, but the invention is not limited thereto. It should be understood that numerous changes to the disclosed embodiments can be made in accordance with the disclosure herein without departing from the spirit or scope of the invention. These examples are therefore not meant to limit the scope of the invention. Rather, the scope of the invention is to be determined only by the appended claims and their equivalents. In these examples all parts given are by weight unless otherwise indicated.

### EXAMPLE 1

### A. General Laboratory Procedure for Making a Powdered Dye Mixture

1) Obtain a Nalgene bottle of appropriate size—approx. 50% larger than the mixture needed.
2) Label the bottle with the experimental mix name, formulation, date, etc.
3) Accurately weight out (±0.1% accuracy) each dye or dye plus other components and place into the Nalgene bottle.
4) Add mixing media; steel balls, steel rods, porcelain rods, etc sufficient to mix the formulation. The steel balls are least aggressive and rods are more aggressive.
5) Roll the mix formulation on a roller-milling machine for 12-48 hours until thoroughly mixed by appearance.
6) Check mix consistency by sampling several times during the mixing procedure and testing for shade/strength consistency from sample to sample.

### B. General Laboratory Procedure for Dyeing Textile Material

Prepare, rinse and neutralize fabric as needed for dyeing process:

1. Prepare dyebath (at room temperature) using deionized water to include the following:
0.15% Cibaflow SF*
1.00% Cibafluid UA*
0.25% Invatex EDTA 30A*
0.50% Unividine DLS*
X % UV Absorber as described above
Y % dye mixture according to the invention (predispersed)
2.00% acetic acid 56% (pH 4.5-5.5)
Z ml cold water to increase volume to the final liquor ratio.
*=available from Ciba Specialty Chemicals Corporation.

Add the material to be dyed to the mixture and take to the laboratory dyeing machine.

2. Machine temperature should be at 120° F. (49° C.). Load dyeing vessel with substrate to be dyed. Run for 10 minutes at 120° F. (49° C.).
3. Heat to 265-280° F. (122-130° C.) at 2° F.-4° F. (1-2° C.) per minute and hold 30-60 minutes depending on difficulty of shade and fabric.
4. Cool to 160° F. (71° C.) and drop bath/remove fabric.
5. Give 2-minute clean, hot tap water rinse
6. If required to improve fastness, give reduction clear on steam bath or hot plate:
a. Prepare new bath volume containing cold, clear water at the same liquor ratio as for dyeing. Add 4.0 g/l soda ash and the fabric and then heat to 160° F. (71° C.).
b. Add 4.0 g/l sodium hydrosulfite and mix for 15 minutes. Drop bath and remove fabric.
c. Give 2-minute clean, hot tap water rinse to the fabric. Drop bath/remove fabric.
d. Prepare 200 ml of clean, hot tap water and add 0.5% acetic acid-56% (based on substrate weight). Agitate for 2 minutes and then give brief clear, cold water rinse. Extract and dry fabric.

### C. General Laboratory Pad-Print or Pad Steam Procedure for Dyeing Textile Material, Especially Polyester or Polyester Blends

Prepare, rinse and neutralize fabric as needed for dyeing process:

1. Prepare dyebath (at room temperature) using deionized water to include the following:
3.0 g/l Cibaflow SF*
0.50 g/l Invatex EDTA 30A*
X % UV Absorber as described above
Y % dye mixture according to the invention (predispersed)
3.0 g/l acetic acid 56% (pH 4.5-5.5)
Z ml cold water to increase volume to the final liquor volume.
*=available from Ciba Specialty Chemicals Corporation.
   2. Prepare material to be dyed and take to the laboratory dyeing machine.
   3. Set pad pressure, speed, and steamer temperature (350° F. (177° C.) for 8 minutes).
   4. Add pad liquor and pad sample.
   5. Give 2-minute clean, hot tap water rinse
   6. If required to improve fastness, give reduction clear on steam bath or hot plate:
   a. Prepare new bath volume of cold, clear water at a 10/1 liquor ratio. Add 4.0 g/l soda ash and then heat to 160° F. (71° C.).
   b. Add 4.0 μl sodium hydrosulfite and run for 15 minutes. Drop bath and remove fabric.
   c. Give 2-minute clean, hot tap water rinse. Drop bath/remove fabric
   d. Prepare 200 ml of clean, hot tap water and add 0.5% acetic acid-56% (based on substrate weight). Agitate for 2 minutes and then give brief clear, cold water rinse. Extract and dry.

### D. General Laboratory Pad-Thermosol Procedure for Dyeing Textile Material, Especially Polyester or Polyester Blends

Prepare, rinse and neutralize fabric as needed for dyeing process:

1. Prepare dyebath (at room temperature) using deionized water to include the following:
3.0 g/l Irgapadol PT New
1.0 g/l Ultravol SFN
0.50 g/l Invatex EDTA 30A
X % UV Absorber as described above
Y % dye mixture according to the invention (predispersed)
3.0 g/l acetic acid 56% (pH 4.5-5.5)
Z ml cold water to increase volume to the final liquor ratio.
*=available from Ciba Specialty Chemicals Corporation.
   2. Prepare material to be dyed and take to the laboratory dyeing machine.
   3. Set pad pressure, speed, and predryer temperature (300 F (149° C.) for 3 minutes).
   4. Add pad liquor and pad sample. Predry at 300° F. (149° C.) for 3 minutes; then thermosol at 400° F. (205° C.) for 3 minutes.
   5. Give 2-minute clean, hot top water rinse
   6. If required to improve fastness, give reduction clear on boil bath or hot plate by:
   a. Prepare new bath volume of cold, clear water at the 10/1 liquor ratio. Add 4.0 g/l soda ash and then heat to 160° F. (71° C.).
   b. Add 4.0 g/l sodium hydrosulfite and run for 15 minutes. Drop bath and remove fabric.
   c. Give 2-minute clean, hot tap water rinse. Drop bath/remove fabric
   d. Prepare 200 ml of clean, hot tap water and add 0.5% acetic acid-56% (based on substrate weight). Agitate for 2 minutes and then give brief clear, cold water rinse. Extract and dry.

### E. General Procedure for Evaluation of Lightfastness of Dyed Polyester (PES) Fabrics

The lightfastness testing is conducted in an Atlas Cl4000 Weatherometer. The Weatherometer configuration consists of a high intensity xenon bulb supplying sufficient light and heat energy to degrade the substrate and dye chromophore present in the fiber. The light emission spectrum is controlled by a series of light filters such as borosilicate and soda lime filters as in the GMW3414 test method. These filters allow the xenon emission spectrum to be modified and simulate the weathering that occurs when sunlight passes through the glass in an automobile. For this reason automotive window glass is sometimes employed as a filter over the fabric samples as in the TSL2606G test.

Other critical weathering factors such as chamber temperature and humidity are controlled in the Cl4000 in order to supply a repeatable test method. The weathering endpoint is controlled by the energy adsorption onto a black panel present in the apparatus and is usually measured in joules, kilojoules or megajoules.

The evaluation of the degradation of the color of the fabric is measured by several methods. Often a spectral comparison is made between the faded sample and the original non-faded control utilizing a spectrometer such as the Hunter Lab Ultrascan XE or the Xrite CA22.

Colorimetric software such as Helios (supplied by Ciba Specialty Chemicals) is then employed to give a numerical value to the shade change usually in terms of a chroma and hue change or cast change (CIElab deviation). The cast change reported here in terms of delta a (da*) and delta b (db*) units is desired to be as close to zero as possible with a rating greater than 1.00 or less than −1.00 usually being rejected.

The second important numerical evaluation is the color depth loss. The determination of acceptable color loss, reported in the tables below as percent relative strength, is measured by utilizing a typical rating scale such as the American Association of Chemist and Colorist's (AATCC) Grey Scale Shade Change rating, which runs from 1 to 5 with 5 being the best and 1 being the worst. A 3 rating or higher is usually considered acceptable if the cast is also considered acceptable. This rating can also be determined with the colorimetric software.

### EXAMPLE 2

Finely dispersed dye mixtures according to the invention having the amounts of dyes indicated in Table I were prepared as described in Example 1, part A. In all the tables the Roman numerals refer to the dyes disclosed above.

TABLE I

| Dye | Yellow Dyeing | Red Dyeing | Blue Dyeing | Black Dyeing |
|---|---|---|---|---|
| Formula | Mixture A | Mixture B | Mixture C | Mixture D |
| I | 22 | | | 5.6 |
| II | 78 | | | 32.5 |
| VII | | 81 | | 9.1 |
| VIII | | 19 | | |
| IX | | | 46.5 | |
| X | | | 36.5 | 52.8 |
| XI | | | 17 | |
| Total | 100 | 100 | 100 | 100 |

### EXAMPLE 3

The dye mixtures according to Example 2 were blended in the ratios indicated in Tables II and III below and used to dye polyester textile fabrics according the general procedure described in Example 1, part B. Evaluation was as described in Example 1, part E.

TABLE II
Lightfastness Performance of Dye Mixtures after 752 kj of exposure:

| | | | | | | UV Absorber: 0.6% formula 2 + 3 | | |
|---|---|---|---|---|---|---|---|---|
| | | | | | | combined with 0.75% formula 4a | | |
| Substrate: 150/34 round dull knit PES | | | | | CIELAB deviation | | (%) | AATCC |
| | Formulation: Wgt. % Dye Mixture | | | | after 752 KJ | | Relative | Grey Scale: |
| Dye ID# | A | B | C | D | Da* | Db* | Strength | (instrument) |
| 12 | 0.045 | 0.0041 | 0.014 | | −0.11 | −1.74 | 85 | 3-4 |
| 11 | 0.029 | 0.0046 | 0.034 | | −0.07 | −1.13 | 93 | 4 |
| 13 | 0.100 | 0.027 | 0.180 | | −0.22 | −1.27 | 84 | 3-4 |
| 10 | 0.070 | 0.028 | 0 | 0.848 | −0.82 | −0.67 | 86 | 4 |

TABLE III
Lightfastness Performance of Dye Mixtures after 1354 kj of exposure:

| | | | | | | UV Absorber: 0.8% structure 2 + 3 | | |
|---|---|---|---|---|---|---|---|---|
| Substrate: 150/34 round dull knit PES | | | | | CIELAB deviation | | | AATCC |
| | Formulation: Wgt. % Dye Mixture | | | | 1354 KJ | | (%) Relative | Grey Scale: |
| Dye ID# | A | B | C | D | Da* | Db* | Strength | (instrument) |
| 12 | 0.045 | 0.0041 | 0.014 | | −0.46 | −1.11 | 85 | 3-4 |
| 11 | 0.029 | 0.0046 | 0.034 | | −0.15 | −0.36 | 82 | 3-4 |
| 13 | 0.100 | 0.027 | 0.180 | | −0.25 | −0.28 | 85 | 3-4 |
| 10 | 0.070 | 0.028 | 0 | 0.848 | −0.40 | −0.04 | 83 | 3-4 |

### EXAMPLE 4

### Comparative

State of the art dyes were used to dye polyester textile fabrics according the general procedure described in Example 1, part B. Evaluation was as described in Example 1, part E.

TABLE IV

| Substrate: 100/33 round knit PES | | | | | UV Absorber: (various) | | | |
|---|---|---|---|---|---|---|---|---|
| | Formulation: % Dye Mixture for shade | | | | CIELAB deviation | | (%) | AATCC |
| | #9 | | | | 1354KJ | | Relative | Grey Scale: |
| UV Absorber | Dye VI | Dye XVII | Dye Xa | Dye XII | Da* | Db* | Strength | (instrument) |
| 1.0% 4a | 0.144 | 0.080 | 0.048 | 0.011 | −1.97 | −0.61 | 80 | 3 |
| 0.80% 2 + 3 | 0.144 | 0.080 | 0.048 | 0.011 | −0.16 | −1.03 | 80 | 3 |
| 0.50% 2 | 0.144 | 0.080 | 0.048 | 0.011 | −0.81 | −1.27 | 82 | 3-4 |

We claim:

1. A dye mixture which comprises:
(A) a yellow-dyeing mixture of the dye of the formula I 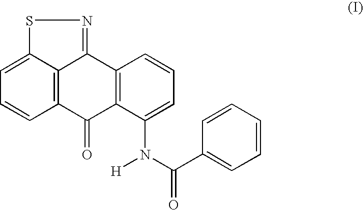
together with the dye of the formula II 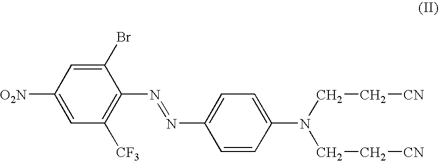
or the dye of the formula III 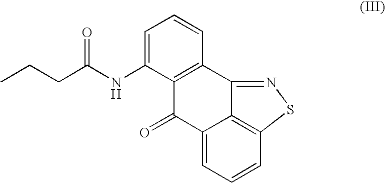
or the dye of the formula IV 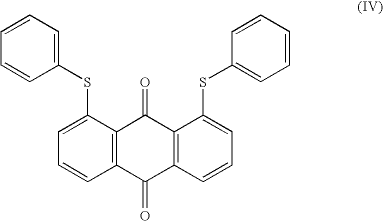
or the dye of the formula V 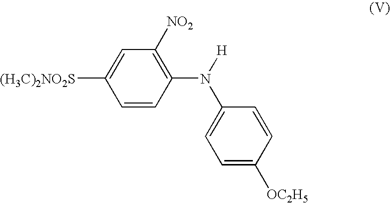
or the dye of the formula VI 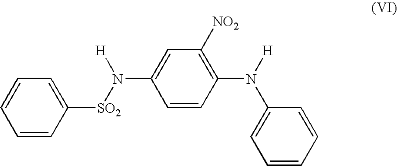
or with a mixture of two or more dyes of the formulae (II)-(VI);
or the dye of the formula IV 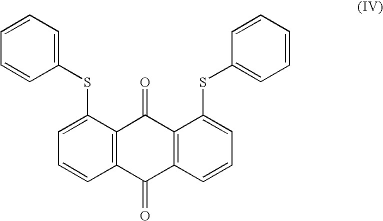
together with the dye of the formula II 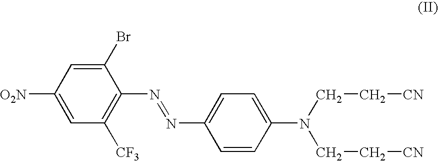
and/or the dye of the formula III 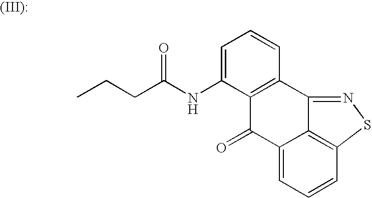
or
(B) a red-dyeing mixture comprising a mixture of dyes of the formulae VIIa-VIIf 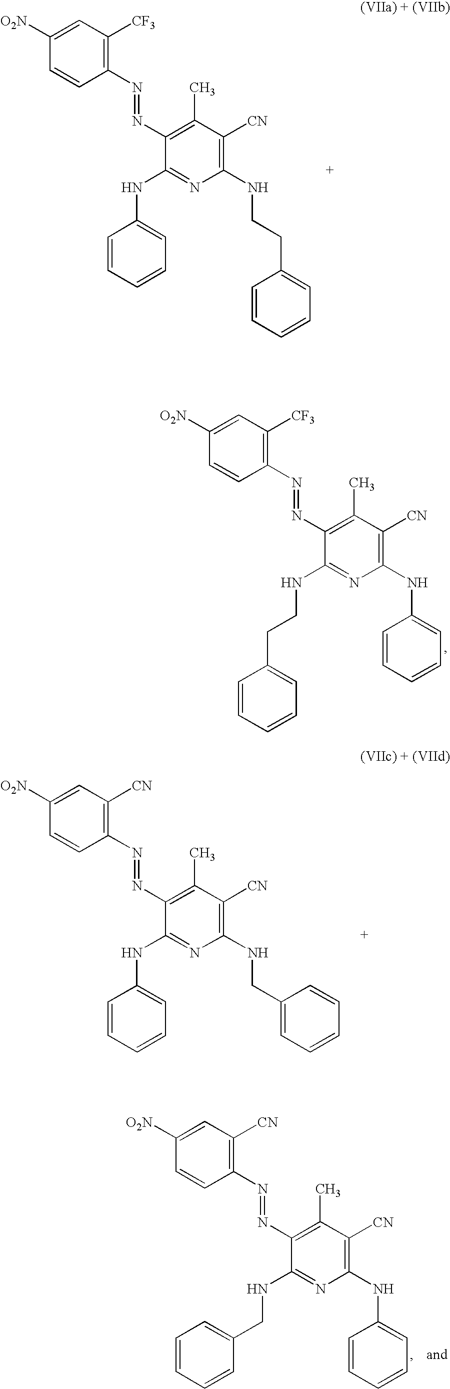 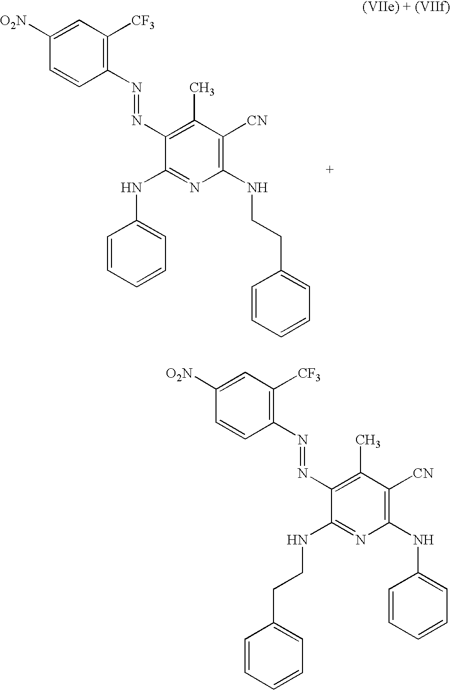
together with a mixture of the dyes formula VIII 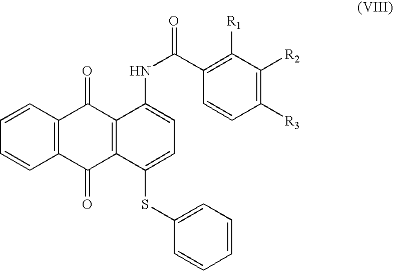
where one of R₁, R₂ and R₃ is Cl and, in each case, the other two substituents are both H;
or
(C) a blue-dyeing mixture comprising the dye of the formula IX 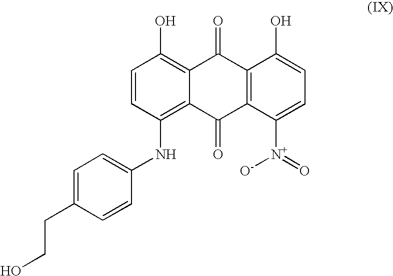
together with a mixture of dyes of the formulae Xa and Xb 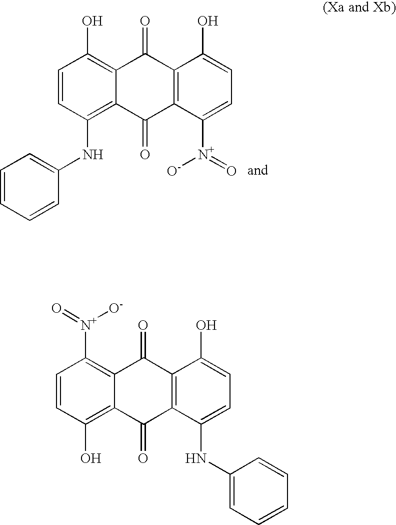
and, optionally, also the dye of the formula XI 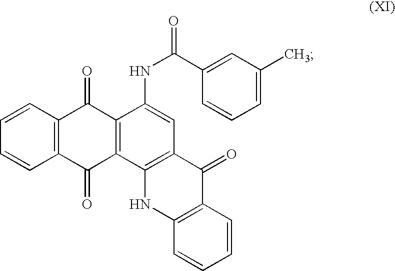
or a blue-dyeing mixture comprising the dye of the formula IX 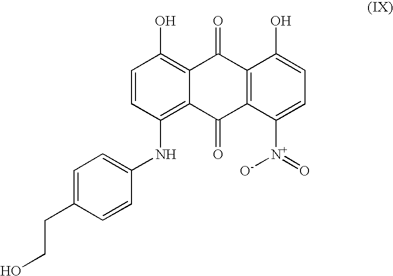
together with a mixture of dyes of the formulae XIII plus Xa 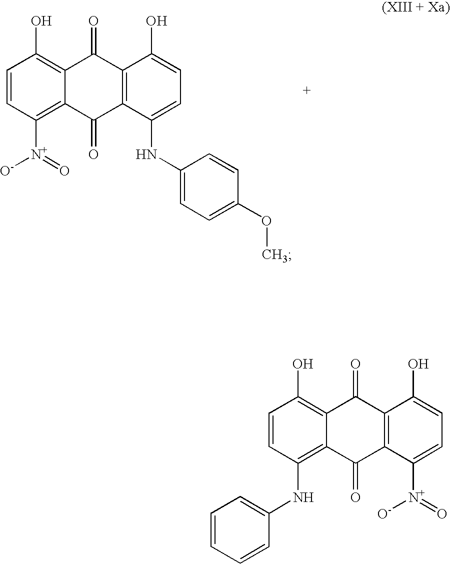
or
(D) a black-dyeing mixture comprising the dye of the formula I 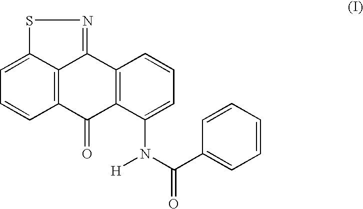
and the dye of the formula IV 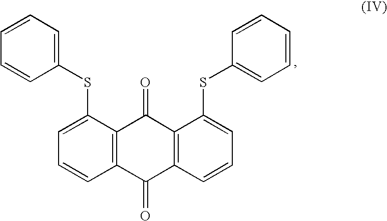
or a mixture comprising the dye of the formula I and/or the dye of the formula II together with the dye of the formula II 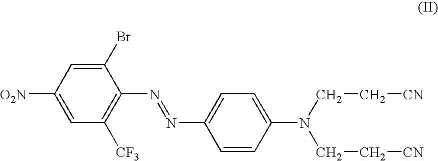
together with a mixture of dyes of the formulae VIIa-VIIf 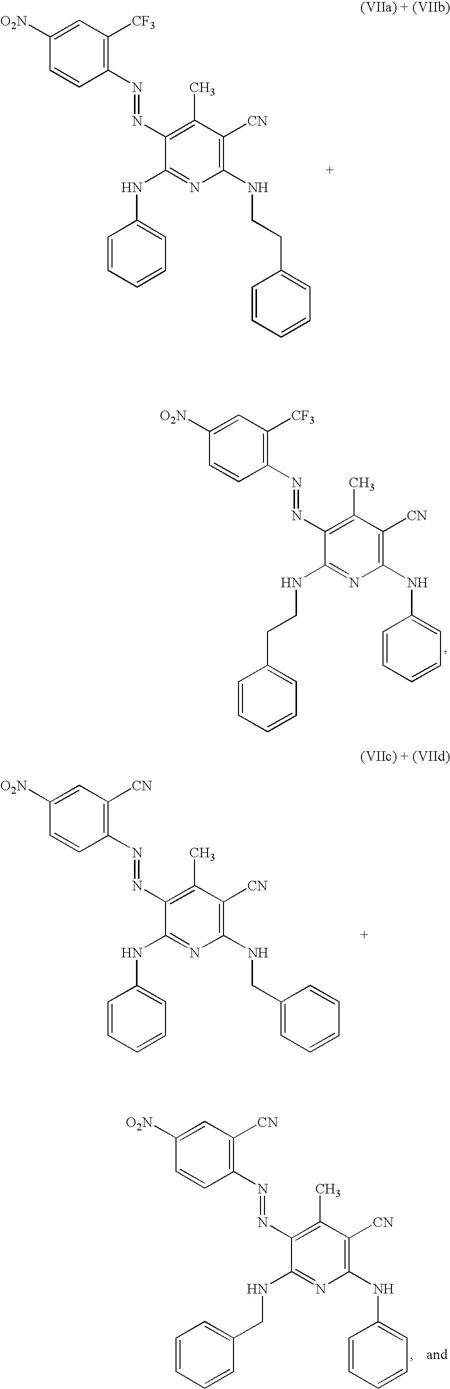 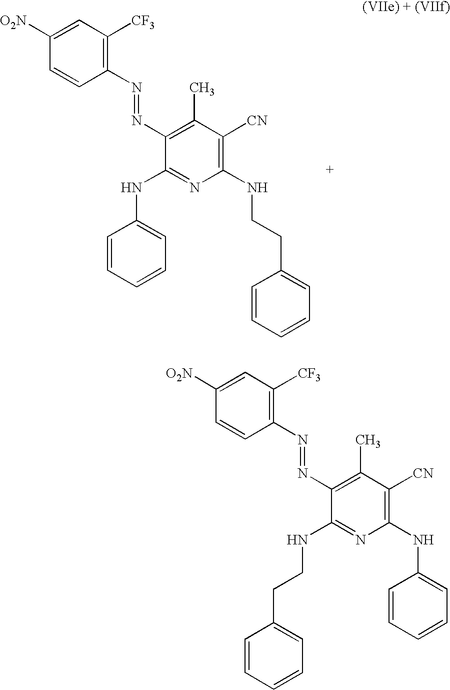
together with a mixture of dyes of the formula Xa and Xb

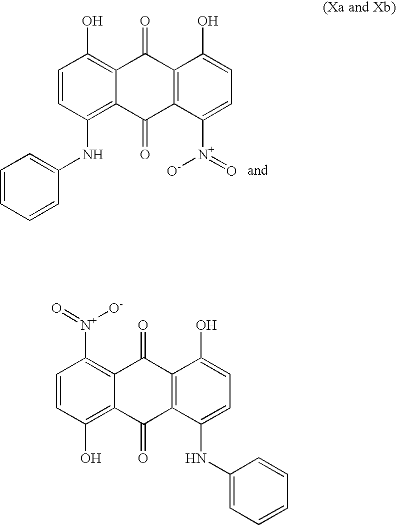

2. A dye mixture according to claim 1, which comprises:
(A) a yellow-dyeing mixture of the dye of the formula I 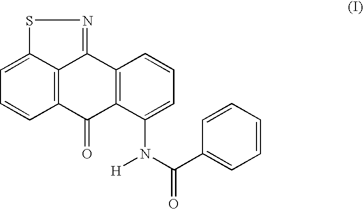
together with the dye of the formula II 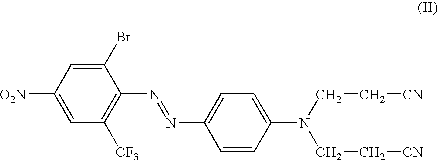
or
(B) a red-dyeing mixture comprising a mixture of dyes of the formulae VIIa-VIIf 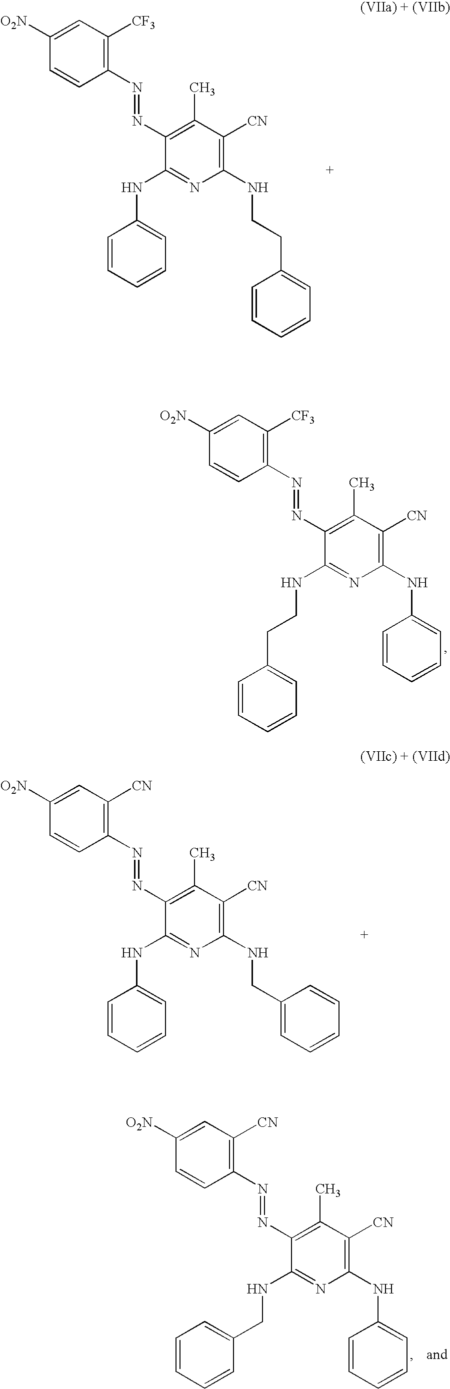 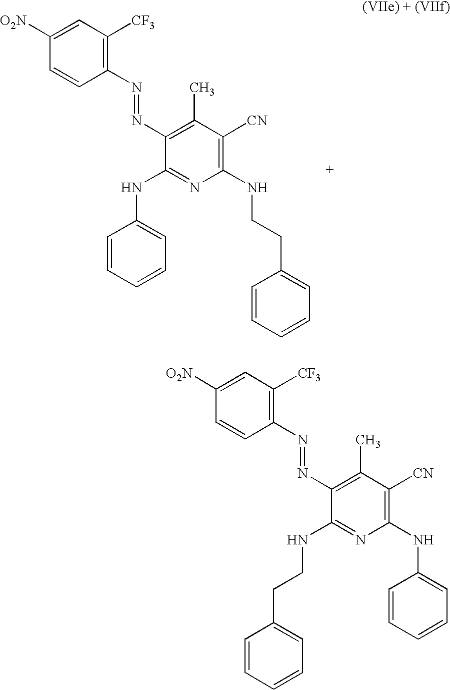
together with at least one dye of the formula VIII 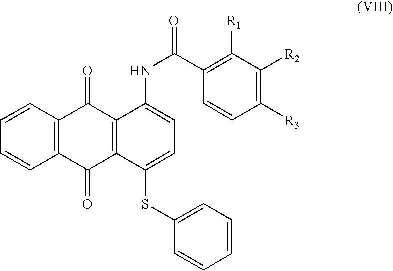
or
(C) a blue-dyeing mixture comprising the dye of the formula IX 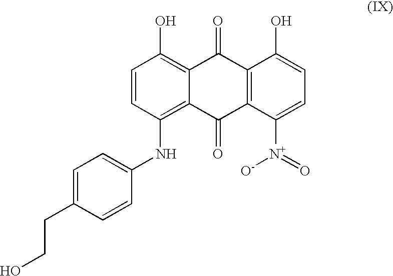
together with a mixture of dyes of the formulae Xa and Xb 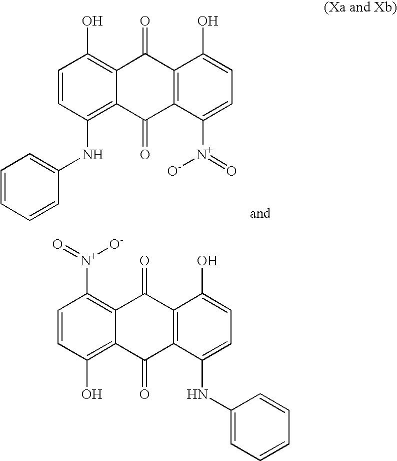
and/or the dye of the formula XI 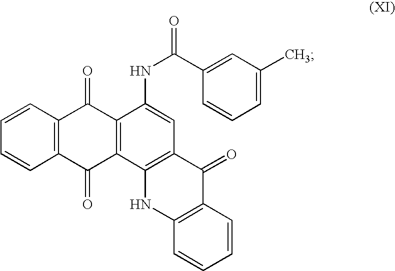
or
(D) a black-dyeing mixture comprising the dye of the formula I 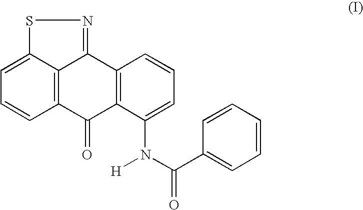
together with the dye of the formula II 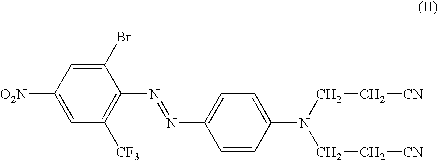
together with a mixture of dyes of the formulae VIIa-VIIf 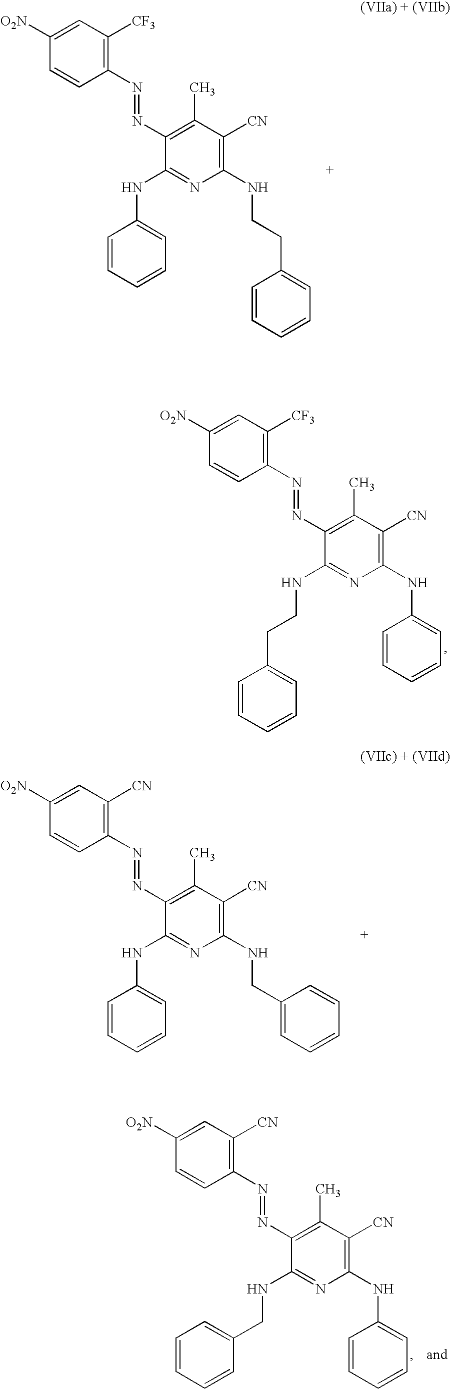 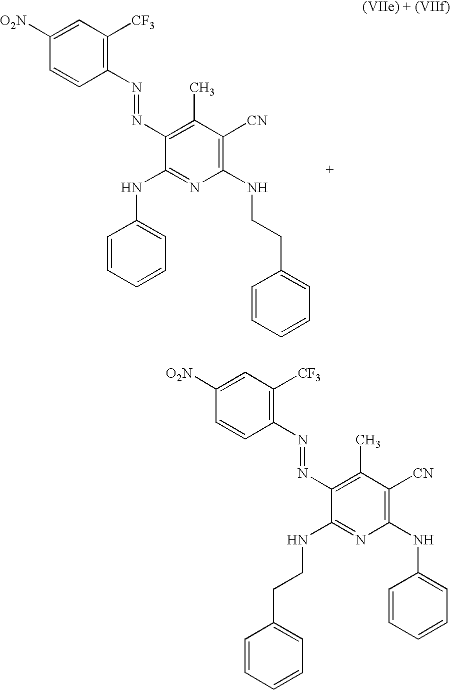
together with a mixture of dyes of the formula Xa and Xb

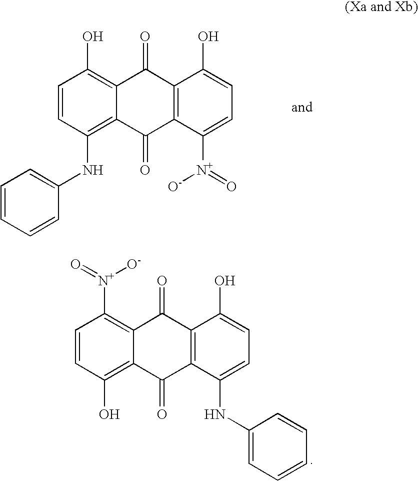

3. A dye mixture according to claim 1, which is a dichromatic or trichromatic mixture comprising two, three or all four of the mixtures (A), (B), (C) and (D).

4. A dye mixture according to claim 1, which comprises any one of the dye mixtures (A), (B), (C) or (D), or any combination thereof, in combination with further dyes.

5. A dye mixture according to claim 4, which comprises as further dyes:
a mixture of dyes of the formula XIV 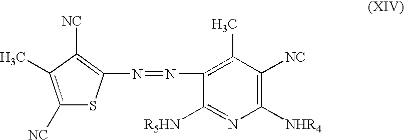
where one of R₄ and R₅ is H and the other is (CH₂)₂O(CH₂)₂OCOCH₃ or (CH₂)₂O(CH₂)₂OH or the dye of the formula XV 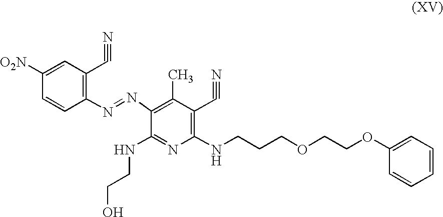
or the dye of the formula XVI 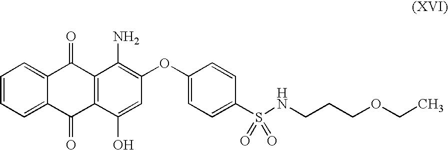
or the dye of the formula XVII 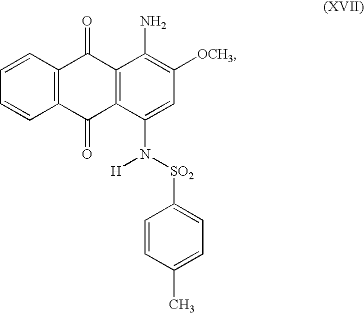
or a mixture of dyes of the formulae XVIIIa and XVIIIb 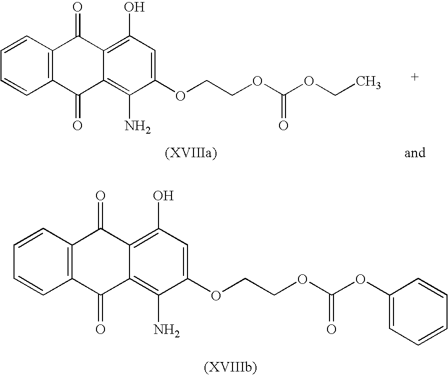
or a dye of the formula XIX 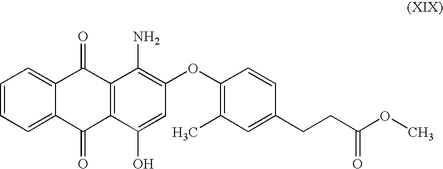
or a mixture of dyes of the formulae XXa and XXb 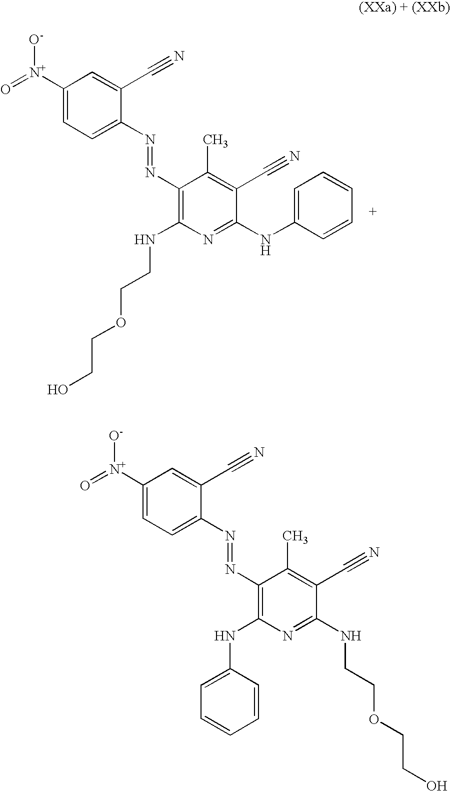
or any combination thereof, in combination with any of the dye mixtures (A), (B), (C) or (D) or any combination thereof.

6. A dye mixture according to claim 5, which comprises, in addition to the red-dyeing mixture (B) or as a replacement for it, at least one of the dyes or dye mixtures of the formula XIV to XXa+XXb.

7. A dye mixture according to claim 4, which comprises as further dyes:
the dye of the formula XXI 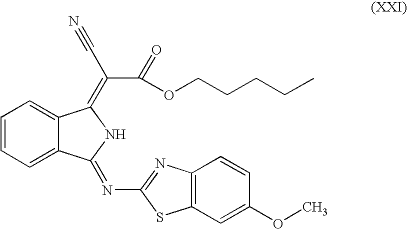
and/or the dye of the formula XXII 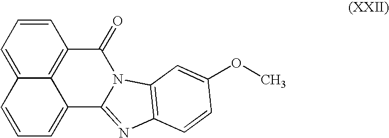
in combination with any of the dye mixtures (A), (B), (C) or (D) or any combination thereof.

8. A dye mixture according to claim 4, which comprises as further dyes:
the dye of the formula IX 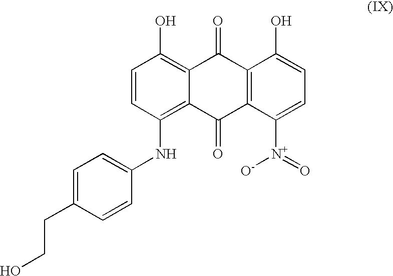
together with the dye of the formula Xa 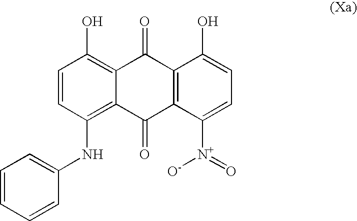
alone, or together with a mixture of dyes of the formulae 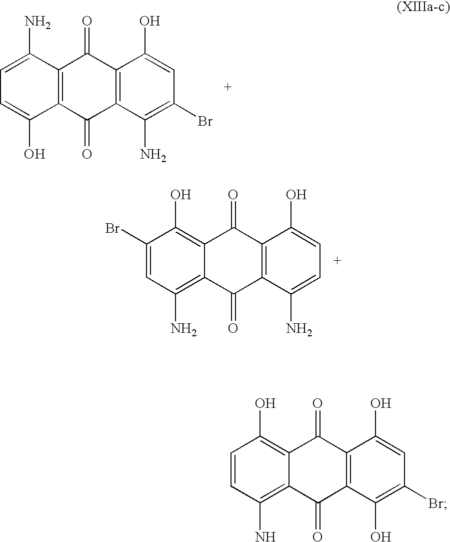
in combination with any of the dye mixtures (A), (B), (C) or (D) or any combination thereof.

9. A dye mixture which according to claim 1, wherein:
the dye mixture (A) comprises from 5 to 90 weight % of the dye of the formula I in combination with from 10 to 95 weight % of at least one dye of the formula II-VI;
the dye mixture (B) comprises from 1 to 99 weight % of the dye mixture of the formulae VIIa-VIIf in combination with from 1 to 99 weight % of the dye mixture of the formulae VIII;
the dye mixture (C) comprises from 1 to 99 weight % of the dye of the formula IX in combination with from 1 to 99 weight % of the dye mixture of the formula Xa+Xb and, optionally, from 0 to 60 weight % of the dye of the formula XI;
or from 1 to 99 weight % of the dye of the formula IX in combination with from 1 to 99 weight % of a dye of the formula Xa in combination with a dye mixture of the formula XIIa-c or a mixture of dyes the formulae XIII plus Xa, and
the dye mixture (D) comprises from 1 to 40 weight % of the dye of the formula I and/or the dye of the formula IV in combination with from 0 to 60 weight of the dye of the formula If plus from 2 to 25 weight % of the dye of the formula VIIa-VIIf, VII, XIV, XV, XVI, XVII, XVIIIa+XVIIIb, XIX or XXa+XXb and from 15 to 80 weight % of the dye mixture of the formulae Xa+Xb, wherein said dyes are as defined in claim 1.

10. A dye preparation, which comprises 10 to 60% by weight of at least one dye mixture according to claim 1, and 40 to 90% by weight of a dispersant, based on the total weight of the dye mixture and dispersant.

11. An aqueous dye preparation according to claim 10, which comprises 5 to 50% by weight of the dye mixture, 10 to 25% by weight of a dispersant, the balance being water and further auxiliaries in conventional amounts, each based on the dye preparation.

12. A dye liquor, which comprises at least one of the dye mixtures (A), (B), (C) or (D) according to claim 1, alone or in combination with other dyes, and, optionally, at least one UV absorber.

13. A dye liquor according to claim 12 which comprises at least one UV absorber, wherein the UV absorber is an s-triazine UV absorber, a benzotriazole UV absorber, a benzophenone UV absorber, or a mixture thereof.

14. A dye liquor according to claim 13, wherein the s-triazine UV absorber is of the formula 1 or 2 or is a mixture of the formulae 2+3

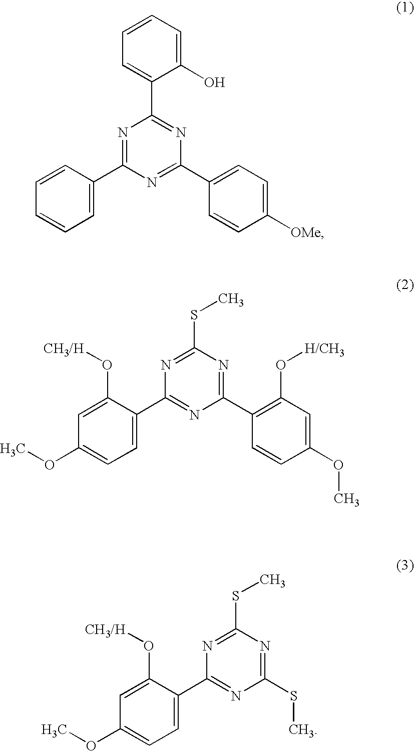

15. A dye liquor according to claim 14, wherein the s-triazine UV absorber is of the formula 1 or is the mixture of the formulae 2+3.

16. A dye liquor according to claim 13, wherein the benzotriazole UV absorber is a compound of the formula 4 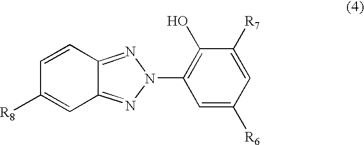
wherein R₆ is halogen, C₁-C₁₂alkyl or C₁-C₁₂alkoxy and R₇ and R₈ are each independently of the other hydrogen, halogen, CF₃, C₁-C₁₂alkyl or C₁-C₁₂alkoxy.

17. A dye liquor according to claim 16, wherein the benzotriazole UV absorber is the compound of formula 4a

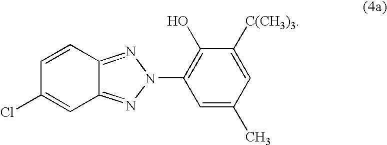

18. A dye liquor according to claim 13, which comprises 0.02% to 3% by weight of at least one UV absorber.

19. A method of dyeing or printing hydrophobic fiber materials, which comprises contacting said materials with a dyeing or printing composition comprising a tinctorially effective amount of at least one dye mixture (A), (B), (C) or (D) according to claim 1, alone or in combination with other dyes, and, optionally, at least one UV absorber.

20. A method of dyeing hydrophobic textile fiber materials according to claim 19, wherein said dyeing is in accordance with the pad bake and/or thermosol process, or in the exhaust process or in a continuous process.

21. A method of printing hydrophobic textile fiber materials according to claim 19, which comprises incorporating at least one dye mixture according to claim 19 into a print paste, printing the fabric therewith and treating the fabric printed therewith at temperatures between 140 to 230° C. with superheated steam or dry heat to fix the dyes, optionally in the presence of a carrier.

22. Hydrophobic fibre material, which has been dyed or printed by the process according to claim 19.
